(19) United States
(12) Patent Application Publication
(10) Pub. No.: US 2024/0301101 A1
(43) Pub. Date: Sep. 12, 2024

(54) DISENTANGLED ULTRA-HIGH MOLECULAR WEIGHT POLYETHYLENE, METHODS OF MAKING AND USING

(71) Applicant: King Abdullah University of Science and Technology, Thuwal (SA)

(72) Inventors: Sanjay RASTOGI, Thuwal (SA); Dario ROMANO, Thuwal (SA); Ravindra GOTE, Thuwal (SA)

(21) Appl. No.: 18/572,318

(22) PCT Filed: Jun. 28, 2022
(86) PCT No.: PCT/IB2022/056014

§ 371 Date: Dec. 20, 2023

Related U.S. Application Data
(60) Provisional application No. 63/215,620, filed on Jun. 28, 2021.

(51) Int. Cl. C08F 110/02

(52) U.S. Cl. CPC C08F 110/02; C08F 2410/07

(57) ABSTRACT

Disclosed herein are methods for synthesis of ultra-high molecular weight polyethylene (UHMWPE), with improved disentanglement, for solid-state processing into a product, such as tapes, films, and ropes, etc., with superior mechanical properties. The method includes using a catalyst support which includes MgCl₂ pre-reacted with different alcohols. The MgCl₂/alcohol adducts are reacted with different aluminum alkyls to form nanoparticles support, preferably in-situ, under inert environment in the presence of the monomer used to synthesize the UHMWPE. The resulting heterogeneous catalytic system and polymer synthesis method results in improved UHMWPE with high average molecular weight (Mw)>1 million g/mol, with lower levels of entanglement (while avoiding fouling seen with homogenous catalytic systems), allowing for processing into products such as tapes with superior mechanical properties.

### CROSS-REFERENCE TO RELATED APPLICATION

The present application claims priority to U.S. Application No. 63/215,620 filed Jun. 28, 2021, the disclosure of which is incorporated herein by reference in its entirety.

### FIELD OF THE INVENTION

The invention is generally directed to disentangled ultra-high molecular weight polyethylene and methods of making and using thereof.

### BACKGROUND OF THE INVENTION

Ultra-high molecular weight polyethylene (UHMWPE) having weight average molar mass (M_{w}) greater than one million g/mol is widely used for high demanding applications, but cannot be processed by conventional methods due to the extremely high melt viscosity of the polymer, resulting from the large number of entanglements between chains. The greater the entanglement, the higher the melt viscosity and the more difficult the material is to process. This is particularly true for commercially available UHMWPE, which is mainly synthesized using heterogeneous Ziegler-Natta catalysts. These catalysts, in their basic formulation, are composed of TiCl₄ epitaxially absorbed on MgCl₂ and activated with aluminum alkyls (AlR₃): the spatial proximity of Ti active sites, coupled with the high polymerization temperatures normally used in industrial process, results in the formation of a considerable number of entanglements between the growing chains. There remains a need for improved methods for making UHMWPE with improved disentanglement, and thus, improved processability.

Therefore, it is an object of the present invention to provide UHMWPE with improved disentanglement.

It is a further object of the present invention to provide products with improved mechanical properties made from the disentangled UHMWPE.

It is a further object of the present invention to provide methods for preparing the disentangled UHMWPE.

It is a further object of the present invention to provide methods for using the disentangled UHMWPE.

### SUMMARY OF THE INVENTION

Disclosed herein are methods for synthesis of ultra-high molecular weight polyethylene (UHMWPE), with improved disentanglement, for solid-state processing into products, such as tapes, films, and ropes, etc., with superior mechanical properties.

The method includes using a catalyst support of MgCl₂ pre-reacted with different alcohols including, but not limited to ethanol, 1-butanol, tert-butanol, 3-methyl-1-butanol, 1-pentanol, cyclohexanol, 2-methyl-1-cyclohexanol, 1-octanol, 2-ethyl-1-hexanol), which is reacted with different aluminum alkyls to form a nanoparticle support. The nanoparticle support is preferably formed in-situ, in the presence of the monomer used to synthesize the UHMWPE.

Also disclosed are polymeric compositions of disentangled UHMWPE. Preferably, the UHMWPE has an average molecular weight >1 million g/mol, for example >2 million g/mol, >3 million g/mol, >4 million g/mol. UHMWPE synthesized using a supported system as disclosed herein results in a polymer with well-defined morphology leading to tensile strength and tensile modulus of 4.0 GPa and 200 GPa, respectively, in the uniaxial oriented systems. The well-defined spherical morphology, equivalent to sand particles, is desired for the ease in solid-state processing at the commercial scale. The optical micrographs of the polymer synthesized using the heterogeneous catalytic system show fine spherical morphology compared to the flake-like morphology obtained for the homogeneous catalytic systems. The aspect ratio in the flake morphology is at least 10:1 for 90% of the polymer synthesized using a homogeneous catalytic system; the spherical morphology where this variation is in the maximum order of 2:1, preferably in the order of 1.5:1, and most preferably in the order of 1:1 for at least 95% of the synthesized polymer. The aspect ratio refers to the ratio of the major dimension and minor dimension of a polymeric particle.

Also disclosed are products made from disentangled UHMWPE (for example, tapes and films) with improved mechanical properties when compared to products (for example, tapes and films) made from disentangled UHMWPE synthesized using a homogeneous catalytic systems that do not rely the disclosed heterogeneous catalytic synthesis of disentangled UHMWPE.

### BRIEF DESCRIPTION OF THE DRAWINGS

FIGS. 1A-1C show transmission electron microscopy examples of the nano support synthesized in-situ.

FIGS. 2A-2C show melting kinetics example of UHMWPE synthesized in this work (FIG. 2A), (FIG. 2B) disentangled UHMWPE synthesized using a homogeneous catalytic system; (FIG. 2C) commercially available entangled UHMWPE synthesized using Ziegler-Natta catalytic system. FIG. 2D overlay of area ratio for commercially available entangled UHMWPE synthesized using Ziegler-Natta catalytic system, disentangled UHMWPE synthesized using a homogeneous catalytic system and UHMWPE synthesized in this work.

FIG. 3 shows examples of oscillation time equilibration of UHMWPE polymers synthesized using a homogeneous catalytic system (red), a commercially available heterogeneous system (orange) and the polymer synthesized in this work (blue).

FIG. 4 shows example of particle morphology of the polymers produced using homogeneous catalyst (FIG. 4A) and heterogeneous catalyst developed in this work (FIGS. 4B and 4C).

FIGS. 5A-5C show an example of solid-state deformation of the synthesized disentangled UHMWPE (FIGS. 5A and 5C) using a Koffler bench (FIG. 5B).

FIGS. 6A-6B show tensile strength (FIG. 6A) and tensile modulus (FIG. 6B) as a function of draw ratio for the polymers synthesized using a homogeneous catalyst and the polymer synthesized using the disclosed heterogeneous catalysis.

FIG. 7 compares mechanical properties of fibres and tapes (top right, labelled plastic diamond) made from disentangled UHMWPE synthesized using the disclosed methods, showing they outperform all currently available products by a significant margin. This shows competitive advantage of the plastic diamond over the existing materials is apparent. The data is obtained using a 1-lite scale reactor.

FIG. 8 is an illustration showing the solid-state processing of UHMWPE. The step involves—dosing of the synthesised polymer, followed by compaction of the low bulk density powder below its melting point, followed by solid-state drawing.

### DETAILED DESCRIPTION OF THE INVENTION

Ultra-High Molecular Weight Polyethylene (UHMWPE), is an engineering polymer, which can be processed into the strongest man-made fibre where toughness and strength reflects the high molar mass (exceeding 1 000 000 g/mol). To achieve these desirable mechanical properties, the long polymer chains must be disentangled because the entropically favoured entangled state is equivalent to cooked spaghetti. The greater the entanglement, the higher the melt viscosity and the more difficult the material is to process. Disentanglement is currently achieved by the high temperature dissolution of the chains using toxic solvents such as decahydronaphthalene (to produce Dyneema® by DSM) of fluorocarbons (to produce Spectra® by Honeywell). On cooling, the polymer crystallizes with a lower degree of molecular friction (entanglement). This is a cumbersome process using large amounts of solvent (3600 kilotons per year for the production of 40 kilotons of fibre and films!), which needs subsequent treatment as toxic waste.

Unlike the conventional solution spinning, the disclosed methods provide UHMWPE in powder form suitable for “solid-state” processing without using any solvent. This development of the disruptive technology requires a deep understanding of the kinetics of polymerization and crystallization, and the morphology of the non-crystalline domains in the semi-crystalline polymer. These parameters are strongly dependent on the performance of the catalytic system, the reaction temperature, monomer pressure, polymerization time and reaction medium. Changing these conditions allows the tailored entanglement of the non-crystalline region of the semi-crystalline polymer.

Various approaches have been utilized in an attempt to provide UHMWPE with reduced entanglement; however, the various approaches fall short for various reasons, and the resulting polymer though somewhat disentangled and can be solid state-processed, the resulting mechanical properties fall short compared to those obtained when a homogenous catalyst system is used to generate UHMWPE with low entanglement.

The development of metallocene and post-metallocene catalysts (generally described as “homogenous catalysts”) provided opportunities to produce UHMWPE with reduced number of entanglement by using a homogenous single-site catalyst with significant catalytic activity. The polymer provided a solvent-free route to obtain high strength tapes. (WO 2009/007045). However, the commercial viability of the synthetic route using a homogeneous catalyst is challenged because of reactor fouling, use of large amount of co-catalyst—usually methyl aluminoxane [Al(CH₃O)ₙ, MAO]- and the technological barrier of industry to make a shift from heterogeneous to homogeneous catalytic system. As the reactor size increases, this causes increased fouling of the reactor wall and piping.

Synthesis of low-entangled UHMWPE using supported catalytic systems is disclosed in Ronca, et al., Polymer, 53:2897-2907 (2012). However, lower mechanical properties are achieved in the solid-state uniaxial oriented structures. The polymer as synthesized in Ronca et al resulted in polymer tensile strength and tensile modulus approaching to maximum value of 2.1 GPa and 170 GPa in the uniaxial oriented systems. WO/2010/139720 discloses supporting of catalyst over particles. Although the resulting polymer can be solid-state processed, the resulting mechanical properties are not sufficiently high enough to achieve the same mechanical properties of the homogeneous conditions. The reason is because the support size increases due to particle modification and the resulting polymer is more entangled compared with homogeneous catalysis. WO2015/121162_discloses the synthesis of UHMWPE with a reduced number of entanglements using heterogeneous Ziegler-Natta catalysts. Although the polymer contains a reduced number of entanglements, the polymer produced is bound to be more entangled compared with homogeneous catalysis due to the close proximity of the active sites.

### I. Methods of Making Disentangled UHMWPE

A useful support for the disclosed method should meet the requirement of sufficient distance between the active sites so that the growing chains do not interact significantly with each other. The interaction between the chains is reduced dramatically with the onset of crystallization. To achieve such a scenario the catalyst support should provide the possibility where ideally an active site is anchored to a single particle or during polymerization it disintegrates. A suitable support is preferably in the nanoscale that ranges between 1 and 900 nm, preferably between about 15 and 120 nm, for example, between 20 and 100 nm.

The methods disclosed herein reduces the number of entanglements per chain during polymer synthesis, by judicious choice of a catalytic system, to such an extent that the polymer can be directly processed into (uniaxial drawn) tapes and (biaxial drawn) films below the polymer melting point without using a solvent.

The disclosed methods make use of a heterogeneous catalytic system, which includes catalysts immobilized on a support. The heterogeneous (supported) catalytic system overcomes the challenges of the homogeneous (unsupported) synthesis, for instances eliminating the fouling seen with homogenous catalytic systems. Thus, in a preferred embodiment, a heterogeneous catalyst solution is used, with the catalyst attached to a support rather than being distributed throughout the mixture. The disclosed methods employ a combination of substrates, catalysts and reaction conditions that allow the use of a supported catalyst (i.e., the catalytic system) formed in situ (to avoid agglomeration) and the tuning of polymerisation conditions to achieve the desired disentangled state.

Generally, the methods of making the UHMWPE with reduced entanglement include: (i) heating a mixture of one or more MgCl₂/alcohol adducts and one or more aluminium alkyl compounds at a first temperature for a time period sufficient to form a support; and (ii) mixing the support with a catalyst solution, ethylene, and optionally one or more co-monomers at a polymerization temperature and under a polymerization pressure for a time period sufficient to form the UHMWPE.

Typically, in step (i), the one or more MgCl₂/alcohol adducts and one or more aluminium alkyl compounds are dissolved in a solvent and in the solution phase; in step (ii), the ethylene and optionally one or more co-monomers are in the gas phase. Optionally, the method also includes mixing MgCl₂ with one or more alcohols to form one or more MgCl₂/alcohol adducts prior to step (i) and/or terminating the polymerization reaction in step (ii) using a suitable terminating agent, such as ethanol. Any protic polar solvent and coordinating solvents can be used for deactivation of the catalyst. However, in the polymerization can be terminated with the consumption of ethylene or stopping the ethylene flow.

### A. Synthesis of the MgCl₂/Alcohol Adduct

The method may include a step of mixing MgCl₂ with one or more alcohols to form one or more MgCl₂/alcohol adducts prior to the synthesis of a support and prior to the polymerization reaction. A general formula for the disclosed MgCl₂/alcohol adducts is represented by MgCl₂/(OR′)ₘ, where m is 1 to 6, for example, 1, 2, 3, 4, 5, 6, and each occurrence of OR′ represents an alcohol. For example, when m is 2, each OR′ can be the same or different from each other.

Generally, one or more alcohols were slowly added to a stirred slurry of anhydrous MgCl₂ in n-decane at room temperature to form a reaction mixture, Alternatively, MgCl₂ is slowly added to a stirred a solution of one or more alcohols at room temperature to form a reaction mixture; the reaction mixture is then heated at a suitable temperature for a period of time sufficient to form the one or more MgCl₂/alcohol adducts. The solution of the one or more alcohols can be prepared by dissolving the one or more alcohols in a suitable solvent, such as n-decane. Any apolar, non-coordinative solvent can be used. Such are any aliphatic and aromatic solvents; examples include, but are not limited to toluene, xylenes, benzene, hexane, heptane, gasoline (petrol benzine) and kerosene. Optionally, an organic solvent, such as toluene or heptane, is added in the reaction products to form a solution of the one or more MgCl₂/alcohol adducts.

Any suitable alcohols can be used in forming the MgCl₂/alcohol adducts, such as a linear or branched aliphatic mono-alcohol having between 3 and 20 carbon atoms, between 3 and 16 carbon atoms, between 3 and 12 carbon atoms, or between 6 and 16 carbon atoms. Preferred alcohols used for making the MgCl₂/alcohol adducts, include, but are not limited to ethanol, 1-butanol, tert-butanol, 3-methyl-1-butanol, 1-pentanol, cyclohexanol, 2-methyl-1-cyclohexanol, 1-octanol, 1-pentanol, 2-ethyl-1-hexanol.

In a preferred embodiment, an alcohol (for example, 76.9 mmol) is added to a stirred slurry of MgCl₂ (for example, 2.44 g, 25.6 mmol) in n-decane at room temperature. The resultant mixture is heated at 140° C. for 4 h with constant magnetic stirring until a clear solution is obtained, then allowed to cool to room temperature. A solvent, preferably, toluene or heptane is added to the resulting solution at room temperature to give a 0.5 M MgCl₂/alcohol solution and stored under nitrogen. However, any apolar, non-coordinative solvent can be used. Such are any aliphatic and aromatic solvents.

### B. Synthesis of Nanoparticle Supports

Nanoparticulate solid supports are formed in-situ by heating a mixture of one or more MgCl₂/alcohol adducts and one or more aluminium alkyl compounds at a suitable temperature for a period sufficient to form a support. Suitable conditions include atmospheric pressure to 3 atm (absolute) with a temperature from about 10 to about 60° C., preferably, about 50° C.

A general formula for the disclosed supports is represented by MgClx/AlyRn(OR′)ₘ, where x is between o and 2; y and m range from 0 to 6, i.e., y and m can be 0, 1, 2, 3, 4, 5 or 6; and n is between 0 and 12, i.e., n can be 0, 1, 2, 3, 4, 5, 6, 7, 8, 9, 10, 11, 12. The support in some embodiments can contain an inorganic oxide support, such as silica, alumina, titania, silica-alumina, and silica-titania. However, in some preferred embodiments, the support does not contain an inorganic oxide support, such as silica, alumina, titania, silica-alumina, and silica-titania.

Suitable aluminum alkyl compounds for use in the synthesis of the nanoparticle supports include, but are not limited to, ethylaluminium dichloride, diethylaluminium chloride, ethylaluminium sesquichloride, dimethylaluminium chloride, trimethylaluminium, triethylaluminium, tri-isobutylaluminium, trihexylaluminium, tri-n-octylaluminium, methylaluminiumoxane (MAO), hexaisobutylaluminiumoxane (HIBAO), tetra-iso-butylaluminiumoxane (TIBAO), and isoprenylaluminium. Preferably, the aluminum alkyl compounds used in the synthesis of the nanoparticle supports is not methylaluminiumoxane (MAO). Preferred aluminum alkyls include, but are not limited to, AlMe₃, AlEt₃, AlOct₃, AlEt₂Cl, and AlEtCl₂. The aluminum alkyl in some embodiments is preferably not tri-isobutyl aluminum.

Each of the MgCl₂/alcohol adduct(s) and aluminium alkyl compound(s) are dissolved in a solvent and provided in the solution phase. The solvent can be selected based on the specific MgCl₂/alcohol adducts and the aluminium alkyl compounds used in the reaction. Examples of solvents for preparing the solutions of the MgCl₂/alcohol adducts and/or the aluminium alkyl include, but are not limited to, toluene, heptane, octane, iso-octane, n-decane, varsol, and a combination thereof. The total concentration of the one or more MgCl₂/alcohol adducts in the adduct solution is in a range from about 0.01 M to about 1 M, from about 0.05 M to about 1 M, from about 0.1 M to about 1 M, from about 0.2 M to about 1 M, or from about 0.2 M to about 0.6 M, such as about 0.5 M. The term “total concentration of the one or more MgCl₂/alcohol adducts” refers to the total mole of the adducts relative to the volume of the adduct solution. The total amount of the one or more aluminium alkyl compounds in the aluminium alkyl solution depends on the total concentration of the MgCl₂/alcohol adducts. Typically, the total mole of the one or more aluminium alkyl compounds is between 1 equivalent to 10 equivalent, between 1 equivalent to 8 equivalent, between 1 equivalent to 6 equivalent, between 1 equivalent to 4 equivalent, between 1 equivalent to 3 equivalent, between 1 equivalent to 2 equivalent, or between 1 equivalent to 1.5 equivalent, such as about 1.2 equivalent of the total mole of the adducts.

Generally, the one or more MgCl₂/alcohol adducts and one or more aluminium alkyl compounds are fed in a reactor and heated at a suitable temperature for a period of time sufficient to form the nanoparticle support. The synthesis can be performed under an inert gas environment, such as nitrogen, helium, neon, argon, krypton, xenon, and radon. For example, the inert gas used in the synthesis of the support is nitrogen.

Suitable temperatures for heating the MgCl₂/alcohol adducts and aluminium alkyl compounds to form the support are at least 0° C., at least 10° C., at least 20° C., at least 30° C., at least 40° C., at least 50° C., up to 100° C., up to 90° C., up to 80° C., up to 70° C., in a range from about 0° C. to about 100° C., from about 0° C. to about 90° C., from about 0° C. to about 80° C., from about 0° C. to about 70° C., from about 20° C. to about 100° C., from about 20° C. to about 90° C., or from about 20° C. to about 80° C. In some preferred embodiments the temperature is maximally, between about 50-60° C.

Suitable time period for heating the MgCl₂/alcohol adducts and aluminium alkyl compounds to form the support is up to 2 hours, up to 1.5 hours, up to 1 hour, at least 5 minutes, at least 10 minutes, at least 15 minutes, at least 20 hour, in a range from about 5 minutes to about 2 hours, from about 10 minutes to about 2 hours, from about 20 minutes to about 2 hours, from about 5 minutes to about 1.5 hour, from about 10 minutes to about 1.5 hours, from about 5 minutes to about 1 hour, from about 10 minutes to about 1 hour, or from about 5 minutes to about 40 minutes, such as about 5 minutes, about 30 minutes, about 1 hour, or about 2 hours.

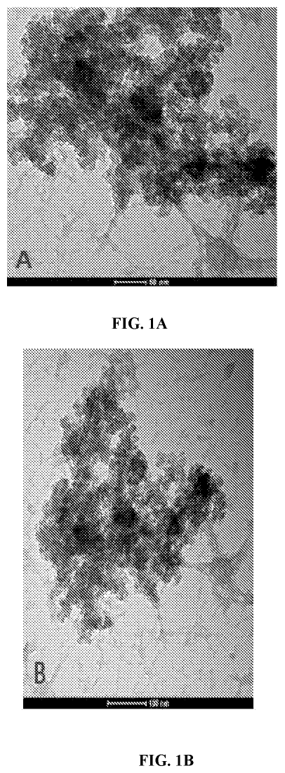

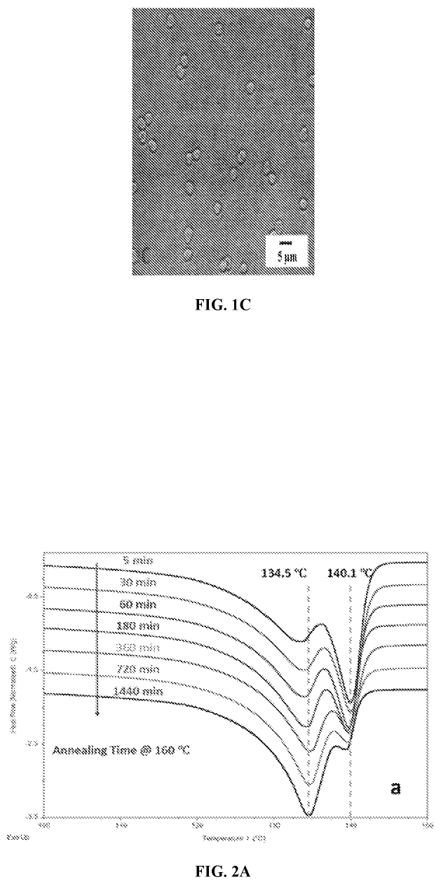

The MgCl₂/alcohol adduct and aluminium alkyl compounds can be heated under any combinations of the temperature and time period described above to form the support. Exemplary reaction conditions are as follows: 1 eq. of MgCl₂/alcohol solution 3.2 eq. of Al alkyl are added to toluene at 50° C. under constant stirring. The reaction is left to react for 30 minutes, resulting in in-situ formed solid nano-supports (FIG. 1A-1B). The nanoparticle support synthesis method disclosed herein preferably does not include reacting the MgCl₂/alcohol with a light petroleum (b.p 40-60° C.); further, the aluminum alkyl preferably is not added to toluene as a mixture with an alcohol.

### C. In-Situ Synthesis of Catalytic System and Polymerization Procedure

The nanoparticle support obtained as a result of the reaction described in (B) is reacted with a suitable catalyst (for example, bis[N-(3-tert-butylsalicylidene)pentafluoroanilinato] titanium (IV) dichloride; however not limited to the given example) to form the final catalytic system, in the presence of ethylene and optionally one or more co-monomers, under the polymerization conditions disclosed below. Any catalyst that is able to produce linear polyethylene having molar mass greater than a million g/mol, and could be supported on the given supports, for example metallocenes and bisphenoxyimines having metallic centers Ti, Zr, or Hf Preferably, the catalytic system is not pre-formed prior to the polymerization procedure, and is this distinguishable from other methods as disclosed for example, in Severn and Chadwick, Macromolecular Chemistry and Physics, 2004, 205, 1987, who do not provide disentangled UHMWPE as their support was pre-formed, resulting in significantly large particle size, in the order of mm. In the disclosed methods, the support is dissolved using alcohols and precipitated in-situ using aluminum alkyls, where the resulting product acts as a catalyst activator and support. This approach leads to the formation of nm size co-catalyst supports that helps in activating the catalyst.

In some preferred embodiments, the polymerization procedure does not use an iron-, chromium-, or vanadium-based precatalyst such as bis(imino)pyridyl iron, bis(imino)pyridyl chromium, or bis(imino)pyridyl vanadium. In preferred embodiments, the catalysts used in the polymerization procedure contain halogen, such as fluorine, chlorine, bromine, or iodine.

Generally, following a first step (i) of heating a mixture of one or more MgCl₂/alcohol adducts and one or more aluminium alkyl compounds to form a support, a catalytic solution is fed into the reactor and mixed with the support formed in step (i). The ethylene and optionally one or more co-monomers are typically in the gas phase, however, they dissolve in the reaction media. The catalytic solution contains one or more suitable catalysts for the polymerization reaction and can be prepared by dissolving the one or more catalysts, such as bis[N-(3-tert-butylsalicylidene) pentafluoroanilinato] titanium (IV) dichloride, in a suitable organic solvent, such as those described above, for example, toluene or heptane, or a combination thereof.

In some embodiments, the catalysts are dissolved in a mixture of toluene and heptane, and the volume ratio of toluene to heptane can be in an range from 0.001 to 1000, from 0.01 to 1000, from 0.1 to 1000, from 1 to 1000, from 10 to 1000, from 20 to 1000, from 50 to 1000, from 80 to 1000, from 100 to 1000, from 0.001 to 500, from 0.01 to 500, from 0.1 to 500, from 1 to 500, from 0.001 to 100, from 0.01 to 100, from 0.1 to 100, or from 1 to 100. The total concentration of the one or more catalysts in the catalyst solution can be in a range from about 0.1 μM to about 100 μM, from about 0.5 μM to about 100 μM, from about 1 μM to about 100 μM, from about 5 μM to about 100 μM, from about 5 μM to about 90 μM, from about 5 μM to about 80 μM, from about 5 μM to about 70 μM, from about 5 μM to about 60 μM, from about 5 μM to about 50 μM, from about 5 μM to about 40 μM, from about 5 μM to about 25 μM, from about 10 μM to about 50 μM, or from about 10 μM to about 30 μM, such as about 15 μM. The term “total concentration of the one or more catalysts” refers to the total mole of the catalysts relative to the volume of the catalyst solution.

The in-situ formation of the catalytic system and polymerization are carried out simultaneously under suitable polymerization conditions, such as at a polymerization pressure of up to 20 atm, up to 15 atm, up to 12 atm, up to 10 atm, up to 9 atm, up to 8 atm, up to 7 atm, up to 6 atm, up to 5 atm, up to 4 atm, up to 3 atm, up to 2 atm, or up to 1.5 atm, in a range from 1 atm to 20 atm, from 1 atm to 15 atm, from 1 atm to 10 atm, from 1 atm to 5 atm, from 1.2 atm to 20 atm, from 1.2 atm to 15 atm, from 1.2 atm to 10 atm, or from 1.2 atm to 5 atm, such as 1.2 atm or 9 atm; a polymerization temperature of about 0° C., at least 10° C., at least 20° C., at least 30° C., at least 40° C., at least 50° C., up to 100° C., up to 90° C., up to 80° C., up to 70° C., in a range from about 10° C. to about 100° C., from about 10° C. to about 90° C., from about 10° C. to about 80° C., from about 10° C. to about 70° C., from about 20° C. to about 100° C., from about 20° C. to about 90° C., or from about 20° C. to about 80° C.; and a polymerization time period of at least 5 to about 120 mins, for example, about 10, 20, 30, 40, 50, 60, 70, 80, 90, 100, 110 and 120 mins. The polymerization conditions used during the polymer synthesis (i.e. temperature, pressure, polymerization time, solvents, etc.) are suitable for industrial scale synthesis.

Exemplary polymerization conditions used in step (ii) are as follows:

TABLE 1
Polymerization reaction conditions

| | From | | To | |
|---|---|---|---|---|
| Al/Metal (molar ratio) | 100 | | 6000 | |
| Monomer Pressure | 1.2 | atm | 9.0 | atm |
| Temperature | 10° C. | | 70° C. | |
| Reaction media (toluene in | 0% | | 100% | |
| heptane; solvent for catalyst) | | | | |
| Polymerization time | 5 | min | 120 | min |

| | | |
|---|---|---|
| Volume | 0.51 | 101 |

Catalyst concentration: 15 μM

The disclosed method preferably does not use Fe, Cr, or V-based precatalysts, which do not contain halogen. Additionally, it is important that the reactant (i.e. ethylene) and the catalysts are mixed with the support simultaneously, following support formation.

A typical polymerization process is described using AlEt₃ and MgCl₂/2-ethyl-1-hexanol adduct as examples of aluminum alkyl and MgCl₂/alcohol adduct, although the reaction conditions can be extrapolated to other disclosed alcohols and aluminum alkyls, using the general reaction conditions shown in Table 1. This was demonstrated in the Examples (Table 2).

A reactor is charged with 0.75 L of dry toluene under nitrogen stream gas and heated to 50° C. under constant stirring. A solution of AlEt₃ and 5 mL toluene and 0.5 M MgCl₂/2-ethyl-1-hexanol adduct solution are added to a reactor respectively and stirred for 30 min to in-situ produce MgCl₂/EtₙAl(2-ethyl-1-hexoxide)₃₋ₙ activator/nanoparticle support. The activator is used herein to refer to the co-catalyst. The dissolved support MgCl₂ in alcohol, reacted with aluminum alkyl forms insoluble adduct. The adduct activates the catalyst. Next, the temperature is set to the desired polymerization temperature, nitrogen gas is replaced with ethylene and a toluene solution of bis[N-(3-tert-butylsalicylidene)pentafluoroanilinato] titanium (IV) dichloride complex is injected to the reactor to start the polymerization and the ethylene pressure is quickly raised to the desired value. The chosen polymerization temperature ranges from 10° C. to 70° C., preferably between 10° C. to 40° C., more preferably 25° C. to 40° C., results into a polymer having the desired mechanical properties. The ethylene pressure is maintained at the desired pressure by a continuous feed. After desired time, the polymerization is terminated by the addition of ethanol (10 ml) into the reactor.

The polymerization procedure disclosed herein is a heterogeneous polymerization procedure, which provides significant advantages over procedures employing homogenous catalysis and procedures disclosed for example, in Huang, et al., J. Mol. Catalysis A: Chemical 260: 135-143 (2006), in which the methods disclosed therein require addition of tri-isobutyl aluminum, a compound which is preferably excluded from the methods disclosed herein, since it inactivates the catalysts used in the disclosed methods. By contrast, the disclosed methods preferably use titanium-based catalyst containing halogen (exemplified herein using bis[N-(3-tert-butylsalicylidene)pentafluoroanilinato] titanium (IV) dichloride) and the addition of AlR₃ (R═CH₃, CH₂CH₃) to the catalyst results in a catalytic system with the desired activity, resulting in superior production of PE with M_{w}>4 million g/ml, compared to M_{w} of about 1 million g/mol (Mᵥ about 2-4 million g/mol) seen with reaction conditions including tri-isobutyl aluminum. Thus, tri-isobutyl aluminum is preferably not included in the polymerization reaction. Additionally, Huang et al (2006) made use of catalysts having different metal centers and the catalyst support with the co-catalyst was prepared ex-situ resulting support size in the order of 80 microns.

### II. Compositions

Polymeric compositions of disentangled ultra-high molecular weight polyethylene (UHMWPE) and products such as tapes processed from disentangled UHMWPE, are disclosed.

### A. UHMWPE Composition

Compositions of the UHMWPE disclosed herein include PE and nanoparticles of the polymeric support used to make the PE. Thus, the disclosed compositions of UHMWPE include nanoparticles made by heating a mixture of one or more MgCl₂/alcohol adducts and one or more aluminium alkyl compounds, preferably, aluminum alkyls, at a suitable temperature for a time period sufficient to form a support, as disclosed above. Preferred aluminum alkyls include, but are not limited to, AlMe₃, AlEt₃, AlOct₃, AlEt₂Cl, and AlEtCl₂. The aluminum alkyls are preferably not tri-isobutyl aluminum.

Typically, the UHMWPE disclosed herein has a weight-average molecular weight (M_{w}) of at least 1, 2, 3 million g/mol, 4 million g/mol, at least 4.5 million g/mol, at least 5 million g/mol, at least 5.5 million g/mol, at least 6 million g/mol, at least 6.5 million g/mol, at least 7 million g/mol, at least 7.5 million g/mol, at least 8 million g/mol, at least 8.5 million g/mol, at least 9 million g/mol, at least 9.5 million g/mol, or at least 10 million g/mol. For example, the UHMWPE disclosed herein has a M_{w} of >4 million g/mol.

The UHMWPE prepared according to the methods disclosed therein have a low molecular weight distribution. The molecular weight distribution preferably ranges from about 2.0 to about 8.0, preferably between about 2.5 to about 6.0.

For molecular weight below 1 million g/mnol, the molecular weight distribution and molecular weight averages (M_{w}, Mₙ, M_{z}) of the polymer are determined in accordance with ASTM D 6474-99 at a temperature of 160° C. using 1,2,4-trichlorobenzene (TCB) as a solvent. Appropriate chromatographic equipment (PL-GPC220 from Polymer Laboratories) including a high temperature sample preparation device (PL-SP260) may be used. The system is calibrated using sixteen polystyrene standards (M_{w}/Mₙ<1.1) in the molecular weight range 5×10³ to 8×10⁶ gram/mol. For molecular weights above 1×10⁶ g/mol the method described in Talebi, et al. Macromolecules 2010; 43 (6); 2780-2788 may be used.

The disentangled UHMWPE can be a homopolymer of ethylene or a copolymer of ethylene and one or more co-monomers that are different from ethylene. When the disentangled UHMWPE is an ethylene copolymer, each of the one or more co-monomers in the UHMWPE can be an alpha-olefin, a cyclic olefin, or a diene that is different from ethylene. The co-monomer can have between 3 and 30 carbon atoms, between 4 and 30 carbon atoms, between 5 and 30 carbon atoms, between 6 and 30 carbon atoms, between 3 and 25 carbon atoms, between 3 and 20 carbon atoms, between 3 and 15 carbon atoms, between 3 and 12 carbon atoms, between 3 and 10 carbon atoms, between 3 and 8 carbon atoms, or between 3 and 6 carbon atoms. Examples of suitable co-monomers for use with ethylene to form the disentangled UHMWPE include, but are not limited to, propene, 1-butene, 1-pentene, 1-hexene, 1-heptene, 1-octene, cyclohexene, butadiene, and 1-4 hexadiene, and a combination thereof. The total amount of the one or more co-monomers in a high molecular weight copolymer of ethylene can be up to 10 mol %, up to 8 mol %, up to 5 mol %, up to 2 mol %, up to 1 mol %, in a range from about 0.001 mol % to 10 mol %, from about 0.01 mol % to 10 mol %, from 0.1 mol % to 10 mol %, from about 0.001 mol % to 5 mol %, from about 0.01 mol % to 5 mol %, from 0.1 mol % to 5 mol %, from about 0.001 mol % to 1 mol %, from about 0.01 mol % to 1 mol %, or from 0.1 mol % to 1 mol %.

### B. Morphology

The UHMWPE can be in the form of particles, which are homogeneous in size and are predominantly spherical in size. The morphology and average diameter of the polymeric particles of the UHMWPE can be determined by known methods, such as Scanning Electron Microscopy using a Carl Zeiss (Leo) 1530 VP FEG-SEM. Typically, the UHMWPE disclosed herein has a narrow particle size distribution. The aspect ratio for the spherical morphology is in the maximum order of 2:1, preferably in the order of 1.5:1, and most preferably in the order of 1:1 for at least 95% of the synthesized polymer. The method of making the support as disclose herein avoids the replication of the support during polymerization i.e., the support size increases due to particle modification and the resulting polymer is more entangled compared with homogeneous catalysis. By contrast, in the disclosed methods, the support is dissolved in alcohol, and precipitates with anchoring of the activator (i.e. co-catalyst). Retrospectively, we have the situation where prior to the aggregation the dissolved support is used for the anchoring of the co-catalyst. This creates the situation when the anchored support particles dispersed in the polymerization medium helps in polymerization followed by crystallization—reducing the number of entanglements per chain.

### C. Disentangled State

The disentangled UHMWPE disclosed herein has a low degree of chain entanglements, which are an improvement over the low entangled state seen with methods of synthesis using other known heterogeneous catalysts, such as the heterogeneous Ziegler-Natta catalysts.

The disentangled state of an UHMWPE can be evaluated by the melting and crystallization kinetics, rheological characterization for example, increase in elastic shear modulus after melting, solid-state deformation, solid-state NMR and/or scanning electron microscopy.

### (i) Melting Kinetics

The melting/crystallization kinetics of an UHMWPE can be measured using differential scanning calorimetry. An exemplary protocol for measuring the melting/crystallization kinetics of an UHMWPE is as follows: (a) heat the UHMWPE from an initial temperature (“Ti”), such as about 50° C., to an annealing temperature (“Tₐ”) which is higher than polyethylene's equilibrium temperature (about 141.5° C.), such as 160, 170, 180, or 190° C.; (equilibrium melting temperature as used herein refers to the highest melting temperature that a polymer can achieve in the unconstrained condition. Thus is an intrinsic property of a semi-crystalline polymer) (b) anneal the UHMWPE for a fixed period of time (“tₐ”), such as 5, 30, 60, 180, 360, 720, or 1440 mins (however, the annealing time can be varied between 1 minute to 1800 mins or more. Any time can be selected); (c) cooling to an isothermal crystallization temperature (“T_{c}”), such as 120, 122, 124, 126, or 128° C., at a suitable temperature decrease rate, such as about 10° C./min; (d) isothermal crystallization at the isothermal crystallization temperature for a fixed period of time (“t_{c}”), such as about 60, about 180, or about 300 min; (e) cooling to the initial temperature, such as about 50° C.; and (f) second heating from the initial temperature, such as about 50° C., to the annealing temperature, such as 160, 170, 180, or 190° C. The melting/crystallization kinetics plot of heat flow versus temperature is based on data acquired during step (f).

Generally, a change in the intensity of one or more melting peaks with the increase of annealing time (i.e. tₐ in step b) is indicative of the disentangled state of the UHMWPE.

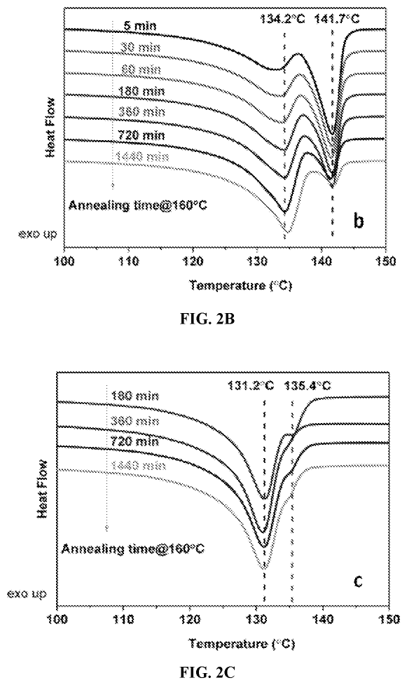

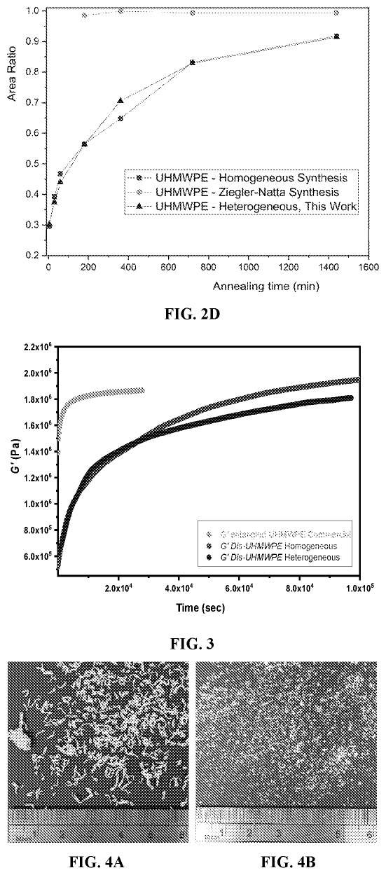

An exemplary melting/crystallization kinetics plot of the UHMWPE disclosed herein is shown in FIG. 2A. As shown in FIG. 2A, the second melting peak area at about 140.1° C. decreases and the first melting peak area at about 134.5° C. increases with the increase of annealing time (i.e. tₐ) in the polymer melt. In contrast, melting/crystallization kinetics plot of a commercially available entangled UHMWPE does not show this feature. Without being bound to any theories, this feature is likely caused by the entanglement formation in the UHMWPE. Accordingly, the changes of the melting peaks intensities as a function of time demonstrates that the UHMWPE disclosed herein is in a disentangled state. The disclosed route for obtaining melting kinetics can be used to differentiate entangled and disentangled state of the synthesized polymer. The disentangled polymer can be deformed in solid state leading to ultimate mechanical properties of 4.0 GPa and 200 GPa for tensile strength and tensile modulus respectively. Rewarding is to see that the polymer synthesized using the heterogeneous catalytic system disclosed herein gives the same DSC (Differential Scanning Calorimetry) response as the polymer synthesized using the homogeneous catalytic system.

ii. Rheological Characterization

The rheological characterization of the UHMWPE can be performed by oscillatory shear measurements, creep and stress relaxation in the linear viscoelastic regime using a suitable rheometer, such as a parallel plate rheometer. The measurements are typically performed at a suitable annealing temperature, with suitable angular frequency and strain. For example, the measurements are performed in the isothermal condition above the melting temperature at about 160° C., at a fixed angular frequency in the range between 0.001 to 600 rad/s, for example 0.01 to 100 rad/s, such as about 10 rad/s in the plateau region, and a constant strain in the linear visco-elastic range between about 0.01% to 10%, such as about 0.5%. The elastic shear modulus determined directly after melting at 160° C. is one of the characterizing features of the disentangled UHMWPE. Samples should show a pronounced increase in modulus with time, confirming the achievement of a disentangled state in the polymer.

Generally, a modulus buildup time increases with increasing molar mass and depending on the disentangled state increases. For an example a polymer with a molar mass greater than a million g/mol can take nearly a day to reach the fully physically entangled state. Some of the examples are shown in the listed publications.

(iii) Solid State-Deformation

Solid-state deformation of the UHMWPE can be performed to further characterize the disentangled nature of UHMWPE. Deformation in the solid state is strongly dependent on the entangled nature of the amorphous region, the entanglements established during the polymerization will have a strong influence in solid state processing. An exemplary method for solid state processing is disclosed in Rastogi et al. Macromolecules 2011, 44, 5558-5568.

A general procedure for the preparation of tapes is as follows: 25 g of polymer powder is poured into a mold with a cavity of 620 mm in length and 30 mm in width and compression-molded at 130 bar for 10 min at 125° C. to form a sheet. The sheet is preheated for at least 1 min and rolled with a Collin calender (diameter rolls: 250 mm, slit distance 0.15 mm, inlet speed 0.5 m/min). The tape is immediately stretched on a roll (speed 2.5 m/min). The rolled and stretched tape is further stretched in two steps on a 50 cm long oil heated hot plate. The tape comes in contact with the hot plate after 20 cm from the entrance of the hot plate. The draw ratio is obtained by dividing specific weight of the sheet prior to deformation by the specific weight of the tape after stretching. A typical processing temperatures of the disentangled polymer include compression molding performed from 115 to 140° C., preferably from 120 to 135° C., even more preferably at 125° C. followed by calendaring performed from 120 to 145° C., more preferably from 125 to 140° C. even more preferably at 130° C. and stretching is performed in two steps; the first and second stretching can be performed from 125 to 160° C., more preferably from 135 to 155° C. even more preferably at 140° C.

### (iv) Molecular Weight Distribution

The molecular weight distribution of the UHMWPE is expressed by the M. (weight average molecular weight) to Mₙ (number average molecular weight) ratio. Typically, the disentangled UHMWPE disclosed herein has a narrow molecular weight distribution, such as less than 12. In some embodiments, the disentangled UHMWPE disclosed herein has a molecular weight distribution of less than 10, less than 8, less than 6, less than 4, less than 3, or less than 2.

The disentangled UHMWPE disclosed herein has improved disentanglement compared with previously reported UHMWPE, such as the UHMWPE prepared using a homogeneous catalytic system as described in WO 2013/076733 by Sarma, et al., commercially available UHMWPE from Sigma Aldrich., disentangled UHMWPE reported in Liu, et al., Macromolecules, 49:7497-7509 (2016).

### III. Methods of Using the Polymers

The disentangled UHMWPE can be processed in the solid-state into a product, such as tapes, films, ropes, etc. Typically, products made by the disclosed disentangled UHMWPE have improved properties, such as high tensile strength and tensile modulus, enhanced UV resistance, abrasion resistance, and high thermal conductivity and electrical resistance. In particular, the products made by the disclosed disentangled UHMWPE can have superior mechanical properties, such as having a tensile strength >4.0 GPa and a tensile modulus >200 GPa. Methods for solid-state processing of polymers into tapes, films, and/or ropes are known, for example, those described in Ronca, et al., Polymers, 53 (2012) 2897-2907. FIG. 8 is an illustration showing the solid-state processing of UHMWPE. The process involves—dosing of the synthesised polymer, followed by compaction of the low bulk density powder below its melting point, followed by solid-state drawing.

Tapes derived from disentangled UHMWPE, with fibers oriented in the draw direction, have unprecedented mechanical properties tensile strength (>4.0 GPa) and tensile modulus (>200 GPa) (FIG. 5), in combination with enhanced UV resistance, abrasion resistance, and a unique high thermal conductivity (equivalent to aluminum) in an electric insulator (equivalent to plastic). The resulting uniaxially oriented tapes have high tensile modulus (200 GPa) and tensile strength (4.0 GPa) comparable with the disentangled-UHMWPE synthesized using homogeneous catalytic systems (FIG. 6). The disclosed disentangled UHMWPE can be processed into biaxially drawn films, that are up to 7 microns thick, having isotopic tensile strength of 0.5 GPa with control over the Gurley index. Up to today, there are no evidence of the synthesis of disentangled UHMWPE using heterogeneous catalytic systems capable to be solid-state processed into tapes having mechanical properties comparable to those obtained using homogeneous catalytic systems like the one developed in this work.

The resulting uniaxially oriented tapes produced can be used to manufacture sports goods, body and vehicle armor, reinforcement of any existing product; in particular the reinforcement of water and oil pipes. The biaxially oriented films can be used as battery separators in lithium-ion batteries or as membranes in liquid purification systems. The nascent powder is suitable for the manufacturing of prosthetic spacers.

The present invention will be further understood by reference to the following non-limiting examples.

### EXAMPLES

The examples below demonstrated the synthesis of MgCl₂ catalyst and use of the catalyst to synthesize disentangled UHMWPE.

The reaction conditions for the synthesis of the MgCl₂ with the alcohols were as follow:

In a round bottom flask under nitrogen stream, at room temperature, to a stirred slurry of anhydrous MgCl₂ (2.44 g, 25.6 mmol) in n-decane (12.25 ml), an alcohol (76.9 mmol) was slowly added. Using a reflux condenser, the resultant mixture was heated at 140° C. for 4 h with constant magnetic stirring until a clear solution is obtained. Once cooled at room temperature, toluene was added to the resulting solution at room temperature to give a 0.5 M MgCl₂/alcohol solution and stored under nitrogen.

The MgCl₂/alcohol/Al alkyl solid adduct was formed in-situ, by reaction of the MgCl₂/Alcohol with an aluminum alkyl (for example, but not limited to, AlMe₃, AlEt₃, AliBu₃, AlOct₃, AlEt₂Cl, AlEtCl₂). The reaction conditions are as follow: In a Buchi stainless steel reactor vessel filled with 750 ml of toluene at 50° C. under constant stirring, 1 eq. of MgCl₂/alcohol solution (in respect to Mg) and 3.2 eq. of Al alkyl were added. The reaction was left to react for 30 minutes to give the in-situ formed solid nano-supports (FIG. 1).

The resulting nano-particle support is reacted with a catalyst (for an example, but not limited to, bis[N-(3-tert-butylsalicylidene)pentafluoroanilinato] titanium (IV) dichloride) to form the final catalytic system under reaction conditions.

The typical polymerization procedure was as follows: Buchi high-pressure metal reactor vessel equipped with a three blade (propeller shaped) overhead mechanical stirrer, a heating/cooling jacket, a press-flow gas dosing system, catalyst/solvents injection valves, digital pressure regulator was used to run the support formation and polymerization reactions. A pre-dried 1.5 L Buchi reactor was kept under high vacuum at 125° C. overnight before usage. The reactor was filled with nitrogen, and after three cycles of vacuum/nitrogen, the reactor was brought at room temperature. Afterwards, it was charged with 0.75 1 of dry toluene under nitrogen stream gas and was heated to 50° C. using a Huber 430 w thermostat under constant stirring. A solution of AlEt₃ and 5 mL toluene and 0.5 M MgCl₂/2-ethyl-1-hexanol adduct solution were added to the reactor respectively and stirred for 30 min to in-situ produce the activator/support. Next, the temperature was set to the desired polymerization temperature, the nitrogen gas was replaced with ethylene and a toluene solution of bis[N-(3-tert-butylsalicylidene)pentafluoroanilinato] titanium (IV) dichloride complex was injected to the reactor to start the polymerization and the ethylene pressure is quickly raised to the desired value. The ethylene pressure was maintained at the desired pressure by a continuous ethylene feed. After desired time, the polymerization was terminated by the addition of ethanol (10 ml) into the reactor.

The resulting catalytic system disclosed herein can be used to promote the polymerization of ethylene into ultra-high molecular weight polyethylene (UHMWPE) having a reduced number of entanglements (disentangled). The disentangled state is corroborated by means of melting/crystallization kinetics experiments (FIG. 2A-C), rheological characterization (FIG. 3) and the ability to be solid-state processed (FIG. 5).

The melting/crystallization kinetic experiments of the UHMWPE synthesized in this work shows a decrease of the second melting peak and an increase of the first melting peak area as a function of time in the melt (FIG. 2A). Comparing the melt kinetics of the polymer obtained using the disclosed methods, the disclosed polymer shows differences in view of commercially available entangled UHMWPE synthesized using a Ziegler-Natta catalytic system (FIG. 2C) and a disentangled UHMWPE obtained using a homogeneous catalytic system. FIG. 2D is an overlay of area ratio for commercially available entangled UHMWPE synthesized using Ziegler-Natta catalytic system, disentangled UHMWPE synthesized using a homogeneous catalytic system and UHMWPE synthesized in this work.

Small strain oscillatory time sweep experiments of the polymers produced, once brought to the melt, show a low starting point of the elastic modulus and a slow increase of the same as a function of time similarly to the disentangled UHMWPE synthesized using a homogeneous catalyst. To recall, the slow increase of the elastic modulus (G′) as a function of time has been assigned to the entanglements formation that reduced the average molecular weight between entanglements (Me) according to the following equation:

$${G}_{n}^{o} = \frac{pRT}{{M}_{e}}$$

where ρ (density), R (gas constant) and T (temperature) are all constant at fixed temperature.

Unlike conventional UHMWPE, which currently requires large quantities of solvent to make fibers and films, the synthesized disentangled UHMWPE allows the environmentally sustainable solid-state production of uniaxially drawn tapes and biaxially drawn films with unprecedented properties.

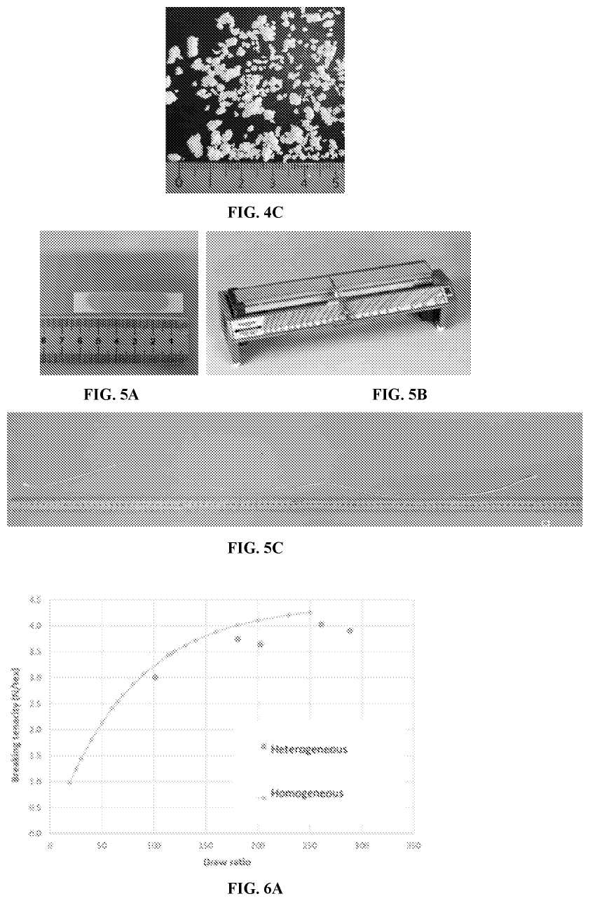

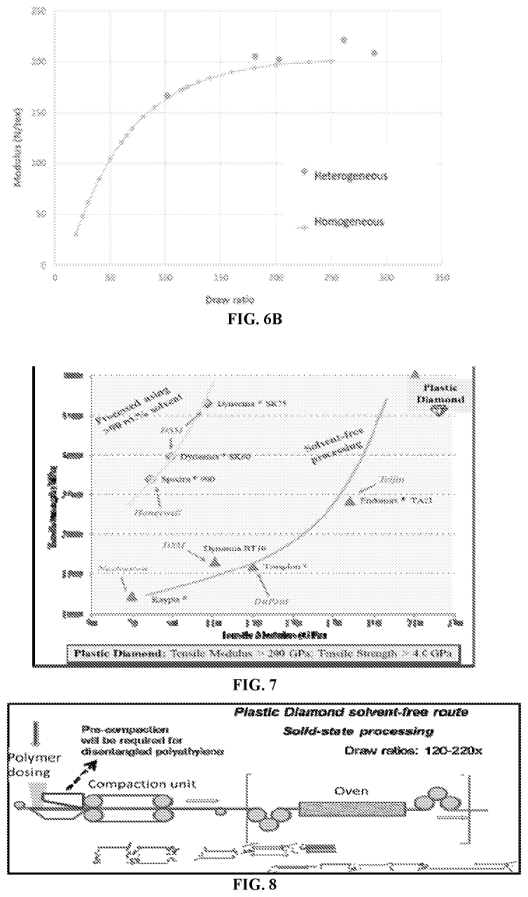

When using the described catalytic system, no reactor fouling is observed and the resulting nascent powder shows controlled particle size (FIG. 4).

TABLE 2
A short summary of the polymers synthesized
in this work

| | Activity | | Bulk | Alcohols used |
|---|---|---|---|---|
| Yield | (kg_{PE}/mol | | Density | in the adduct |
| (g) | cat/h/atm) | Solvent | (g/ml) | formation) |
| 45 | 1005 | Toluene | 0.12 | 2-ethyl-1-hexanol |
| 45 | 1005 | Heptane | 0.10 | 2-ethyl-1-hexanol |
| 18 | 402 | Toluene | 0.20 | Cyclohexanol |
| 9 | 201 | Heptane | 0.15 | Cyclohexanol |
| 16 | 357 | Toluene | 0.10 | n-butanol |
| 27 | 603 | Heptane | 0.07 | n-butanol |
| 25 | 558 | Toluene | 0.10 | n-Octanol |
| 55 | 1227 | Toluene | 0.14 | n-Pentanol |
| 66 | 1473 | Heptane | 0.14 | 3-Me-1-BuOH |
| 28 | 625 | Toluene | 0.16 | Cyclohexanol |
| 2 | 45 | Toluene | 0.13 | Cyclohexanol |
| 64 | 1027 | Toluene | 0.14 | 2-ethyl-1-hexanol |

1. A method for preparing a composition comprising a disentangled ultra-high molecular weight polyethylene (“UHMWPE”) comprising:
(i) heating a mixture of one or more MgCl₂/alcohol adducts and one or more aluminum alkyl compounds at a first temperature for a time period sufficient to form a support; and
(ii) mixing the support with a catalyst solution, ethylene, and optionally one or more co-monomers at a polymerization temperature and under a polymerization pressure for a time period sufficient to form the composition,
wherein the composition comprises the disentangled UHMWPE and the support.

2. The method of claim 1 further comprising mixing MgCl₂ with one or more alcohols to form one or more MgCl₂/alcohol adducts prior to step (i) and/or terminating the polymerization reaction in step (ii) using a suitable terminating agent.

3. The method of claim 1, wherein the one or more MgCl₂/alcohol adducts and one or more aluminum alkyl compounds are dissolved in a first solvent and in the solution phase.

4. The method of claim 1, wherein the MgCl₂/alcohol adduct or each of the MgCl₂/alcohol adducts is represented by:
MgCl₂/(OR′)ₘ
wherein m is 1, 2, 3, 4, 5 or 6, and wherein each occurrence of OR′ represents an alcohol.

5. The method of claim 1, wherein the support is represented by:
MgClₓ/Al_{y}Rₙ(OR′)ₘ
where x is 0, 1 or 2; y and m are independently 0, 1, 3, 4, 5, or 6, and n is 0, 1, 2, 3, 4, 5, 6, 7, 8, 9, 10, 11, or 12.
wherein each occurrence of R represents an alkyl or a halogen, and wherein each occurrence of OR′ represents an alcohol.

6. The method of claim 4, wherein each occurrence of OR′ represents ethanol, 1-butanol, tert-butanol, 3-methyl-1-butanol, 1-pentanol, cyclohexanol, 2-methyl-1-cyclohexanol, 1-octanol, 1-pentanol, or 2-ethyl-1-hexanol.

7. The method of any one of claims 1-6, wherein the aluminum alkyl compound or each of the aluminum alkyl compounds is independently AlMe₃, AlEt₃, AlOc t₃, AlEt₂Cl, or AlEtCl₂.

8. The method of claim 1, wherein the support is in the form of nanoparticles, and optionally wherein the nanoparticles have an average diameter in a range from 1 nm to 900 nm, more preferably from 15 nm to 120 nm.

9. The method of any one of claims 1-8, wherein the ethylene and optionally one or more comonomers are in the gas phase or liquid phase.

10. The method of claim 1, wherein the co-monomer or each of the co-monomers is propene, 1-butene, 1-pentene, 1-hexene, 1-heptene, 1-octene, cyclohexene, butadiene, or 1-4 hexadiene.

11. The method of claim 1, wherein the catalyst solution comprises one or more catalysts and optionally a second solvent, wherein the catalyst or each of the catalysts comprises one or more halogens, and wherein the second solvent is toluene or heptane, or a combination thereof.

12. The method of claim 11, wherein the catalyst or each of the catalysts is a titanium-based catalyst comprising one or more halogens.

13. The method of claim 1, wherein step (ii) is performed at a polymerization temperature in a range from 0° C. to 100° C., preferably 0° C. to 60° C. and under a polymerization pressure in a range from 1 atm to 20 atm, preferably from 1 atm to 4 atm, for a time period in a range from 5 minutes to 120 minutes.

14. A composition comprising a disentangled UHMWPE and a support, wherein the support is represented by
MgClₓ/Al_{y}Rₙ(OR′)ₘ
where x is 0, 1 or 2; y and m are independently 0, 1, 2, 3, 4, 5 or 6 and n is 0, 1, 2, 3, 4, 5, 6, 7, 8, 9, 10, 11, or 12.
wherein each occurrence of R represents an alkyl or a halogen, and wherein each occurrence of OR′ represents an alcohol.

15. The composition of claim 14, wherein the disentangled UHMWPE has a weight average molecular weight (Mw) of >1 million g/mol, a spherical morphology and optionally has an aspect ratio in the order of 1: for at least 95%, and/or a molecular weight distribution of less than 12, preferably in a range from 2.0 to 8.0 or from 2.5 to 6.0.

16. A composition comprising a disentangled UHMWPE, wherein the composition is prepared by the method of claim 1.

17. A product formed by solid-state processing of the composition of any one of claims 14-16.

18. The product of claim 17, wherein the composition is a tape, a film, a fiber or a rope.

19. The product of claim 17, wherein the composition is a uniaxially oriented tape, and wherein the tape has a tensile strength >3.0 GPa and/or a tensile modulus >150 GPa.

20. The product of claim 17, wherein the composition is a biaxially drawn film, and wherein the film has a minimum thickness of up to 7 microns and/or an isotopic tensile strength of 0.5 GPa.
